(19) United States
(12) Patent Application Publication
(10) Pub. No.: US 2026/0018047 A1
(43) Pub. Date: Jan. 15, 2026

(54) FIRE DETECTION SYSTEM WITH TAMPERING DETECTION CAPABILITY AND A METHOD THEREOF

(71) Applicant: Kidde Fire Protection, LLC, Bradenton, FL (US)

(72) Inventor: Jerzy Tlaga, Gdansk (PL)

(21) Appl. No.: 19/256,964

(22) Filed: Jul. 1, 2025

Related U.S. Application Data
(60) Provisional application No. 63/669,780, filed on Jul. 11, 2024.

(51) Int. Cl. G08B 29/04; G08B 17/10

(52) U.S. Cl. CPC G08B 29/046; G08B 17/10

(57) ABSTRACT

A fire detection system having a plurality of fire detectors in a loop, at one of the fire detectors includes a tamper detection circuit having reactive impedance, and a controller connected to the detection circuit. The controller includes a processor with access to a memory storing instructions executable by the processors, which causes the controller to measure time taken by a voltage applied across or a current flowing through the detection circuit to reach a predefined value, measure a time constant of the detection circuit based on the measured time taken, detect if the measured time constant exceeds a predefined threshold, and in response to a positive detection, detect tampering in the fire detector.

### CROSS-REFERENCE TO RELATED APPLICATIONS

This application claims the benefit of U.S. provisional patent application No. 63/669,780 filed Jul. 11, 2024, the entire contents of which are incorporated herein by reference.

### BACKGROUND

Embodiments described herein relate to the field of tampering detection systems and, more particularly, to a fire detection system with tampering detection capability, and a method for detecting tampering thereof.

### SUMMARY

Described herein is a fire detection system having a plurality of fire detectors in a loop, wherein at one of the fire detectors comprises a tamper detection circuit having reactive impedance, and a controller connected to the detection circuit. The controller comprises a processor with access to a memory storing instructions executable by the processors, which causes the controller to measure time taken by a voltage applied across or a current flowing through the detection circuit to reach a predefined value, measure a time constant of the detection circuit based on the measured time taken, detect if the measured time constant exceeds a predefined threshold, and in response to a positive detection, detect tampering in the fire detector.

In one or more embodiments, in response to a negative detection and/or upon a non-detection, the controller is configured to monitor the time constant.

In one or more embodiments, the controller is configured to monitor tampering in the detection circuit at a predetermined interval or in real time.

In one or more embodiments, the controller is configured to issue a detection signal to turn ON or turn OFF supply of electrical power to the detection circuit, and measure the time constant of the detection circuit upon ON or turning OFF the electrical power supply to the detection circuit.

In one or more embodiments, the controller is configured to issue a detection signal to turn ON supply of electrical power to the detection circuit, measure a time delay in the supply of voltage or current to the detection circuit upon turning ON the electrical power supply and correspondingly measure a time taken by a capacitor associated with the detection circuit to be charged to a steady state, and determine the time constant of the detection circuit based on the time taken by the capacitor to be charged to the steady state.

In one or more embodiments, the controller is configured to issue a detection signal to turn OFF supply of electrical power to the detection circuit, measure a time delay in disabling the supply of voltage or current to the detection circuit upon turning OFF the electrical power supply and correspondingly measure a time taken by a capacitor associated with the detection circuit to be fully discharged, and determine the time constant of the detection circuit based on the measured time taken by the capacitor to be fully discharged.

In one or more embodiments, the controller is configured to issue a detection signal to turn ON supply of electrical power to the detection circuit, monitor amplitude of voltage or current associated with the electrical power being supplied to the detection circuit and a time delay in the supply of the voltage or current to the detection circuit upon turning ON the electrical power supply, and determine and record the time constant of the detection circuit based on the monitored voltage or current and the monitored time delay.

In one or more embodiments, the controller is configured to issue a detection signal to turn OFF supply of electrical power to the detector circuit, monitor amplitude of voltage or current associated with the electrical power being supplied to the detection circuit and a time delay in disabling the supply of voltage or current to the detection circuit upon turning OFF the electrical power supply, and determine and record the RC time constant of the detection circuit based on the monitored voltage or current and the monitored time delay.

In one or more embodiments, the controller comprises a comparator that is configured to compare the measured time constant with the predefined threshold range.

In one or more embodiments, the controller comprises a digital to analog convertor (DAC) that is configured to: convert a first digital signal associated with the measured time constant into a first analog signal for the comparator, and/or convert a second digital signal associated with the measured time taken by the voltage and the measured time delay into an analog signal for the comparator.

In one or more embodiments, the controller is a control panel associated with the fire detection system.

Also described herein is a method for detecting tampering in a fire detection system having a plurality of fire detectors in a loop. The method comprises the steps of providing a tamper detection circuit having reactive impedance in at least one of the fire detectors, measuring, by a controller, time taken by a voltage applied across or a current flowing through the detection circuit to reach a predefined value, measuring, by the controller, a time constant of the detection circuit, based on the measured time taken, and detecting, by the controller, tampering in the fire detector when the measured RC time constant is detected to exceed a predefined threshold range.

In one or more embodiments, the method comprises the steps of monitoring, by the controller, tampering in the detection circuit at a predetermined interval or in real time.

In one or more embodiments, the method comprises the steps of issuing, by the controller, a detection signal to turn ON supply of electrical power to the detector circuit, measuring, by the controller, a time delay in the supply of voltage or current to the detection circuit upon turning ON the electrical power supply and correspondingly measuring a time taken by a capacitor associated with the detection circuit to be charged to a steady state, and determining, by the controller, the time constant of the detection circuit based on the time taken by the capacitor to be charged to the steady state.

In one or more embodiments, the method comprises the steps of issuing, by the controller, a detection signal to turn OFF supply of electrical power to the detection circuit, measuring, by the controller, a time delay in disabling the supply of voltage or current to the detection circuit upon turning OFF the electrical power supply and correspondingly measuring a time taken by a capacitor associated with the detection circuit to be fully discharged, and determining, by the controller, the time constant of the detection circuit based on the measured time taken by the capacitor to be fully discharged.

In one or more embodiments, the method comprises the steps of issuing, by the controller, a detection signal to turn ON supply of electrical power to the detection circuit, monitoring, by the controller, amplitude of voltage or current associated with the electrical power being supplied to the detection circuit and a time delay in the supply of the voltage or current to the detection circuit upon turning ON the electrical power supply, and determining and recording, by the controller, the time constant of the detection circuit based on the monitored voltage or current and the monitored time delay.

In one or more embodiments, the method comprises the steps of issuing, by the controller, a detection signal to turn OFF supply of electrical power to the detector circuit, monitoring, by the controller, amplitude of voltage or current associated with the electrical power being supplied to the detection circuit and a time delay in disabling the supply of voltage or current to the detection circuit upon turning OFF the electrical power supply, and determining and recording, by the controller, the RC time constant of the detection circuit based on the monitored voltage or current and the monitored time delay.

In one or more embodiments, the method comprises the steps of generating an alert signal upon detecting tampering in the fire detector.

In one or more embodiments, the controller is a control panel associated with the fire detection circuit.

The preceding summary is illustrative only and is not intended to be in any way limiting. In addition to the illustrative aspects, embodiments, and features described above, further aspects, embodiments, features, and techniques of the subject disclosure will become more apparent from the following description in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label, irrespective of the second reference label.

FIG. 1 illustrates an exemplary representation of a fire detection system having a plurality of fire detectors in a loop, where at least one of the fire detectors is configured with a tampering detection circuit in accordance with one or more embodiments of the subject disclosure.

FIG. 2A illustrates an exemplary block diagram depicting a single fire detector having the tampering detection circuit being connected to a control panel associated with the fire detection system in accordance with one or more embodiments of the subject disclosure.

FIG. 2B illustrates an exemplary circuit diagram of the system of FIG. 2A in accordance with one or more embodiments of the subject disclosure.

FIG. 3 illustrates a schematic flow diagram for a method for detecting tampering in a fire detection system having a plurality of fire detectors in a loop, according to an embodiment of the present disclosure.

FIGS. 4A and 4B illustrate exemplary plots depicting the voltage profile across the tamper detection circuit upon turning ON and turning OFF the supply of electrical power to the detection circuit, according to an embodiment of the present disclosure

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components, as the devices are depicted in the attached drawings. However, as will be recognized by those skilled in the art after a complete reading of the subject disclosure, the components of this invention. Described herein may be positioned in any desired orientation. Thus, the use of terms such as “above,” “below,” “upper,” “lower,” “first,” “second,” or other like terms to describe a spatial relationship between various components or to describe the spatial orientation of aspects of such components should be understood to describe a relative relationship between the components or a spatial orientation of aspects of such components.

Fire detection and alarm systems are employed to ensure the safety of occupants in residential, commercial, and industrial buildings. These systems may be designed to detect signs of fire, such as smoke, heat, or flame, and promptly alert occupants and emergency services to initiate evacuation and firefighting measures. A typical fire detection and alarm system may include multiple fire detectors connected to a central control panel in a loop via cables. The integrity and functionality of these detectors are essential for the system to operate effectively and reliably.

In conventional fire detection and alarm systems, the connection between each fire detector and the control panel includes a pair of wires. These wires may carry detection signals indicating the presence of fire-related conditions, and tamper signals further alerting the control panel to a tampering or interference event with the detector. To facilitate the encoding of these signals, a resistor may be attached to the cable at the detector end. This resistor may ensure the control panel may verify the proper connection and functionality of each detector.

However, a security vulnerability may exist within this design. If an individual gains access to the wiring of the fire detector, they may disable the detector without triggering an alarm. This may be accomplished by attaching a resistor of appropriate value to the cable and then cutting the wires that lead to the actual detector. By doing this, the individual may replicate the expected resistance value that the control panel anticipates during normal operation, thereby tricking the system into believing that the detector is still operational and connected, even though it has been rendered inactive.

Determining the appropriate resistor value is a straightforward process that may involve measuring the voltage drop across the detection cables entering and leaving the detector. This measurement may be passive, meaning it may not involve any active interference or signal generation that may be detected by the fire detection and alarm system.

As a result, the system may remain unaware that the detector has been tampered with and disabled, posing a serious risk to the safety and security of the premises. Given this vulnerability, there is a need for improvements in fire detection and alarm systems to prevent such undetectable tampering. This invention aims to address these vulnerabilities and provide a more secure fire detection and alarm system that may detect and prevent unauthorized tampering with the detectors.

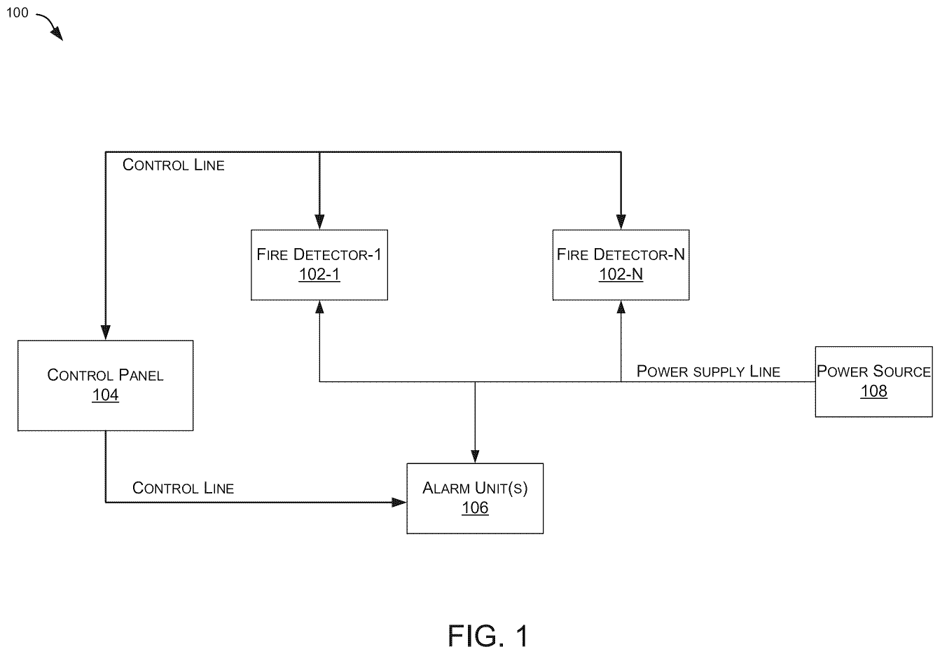

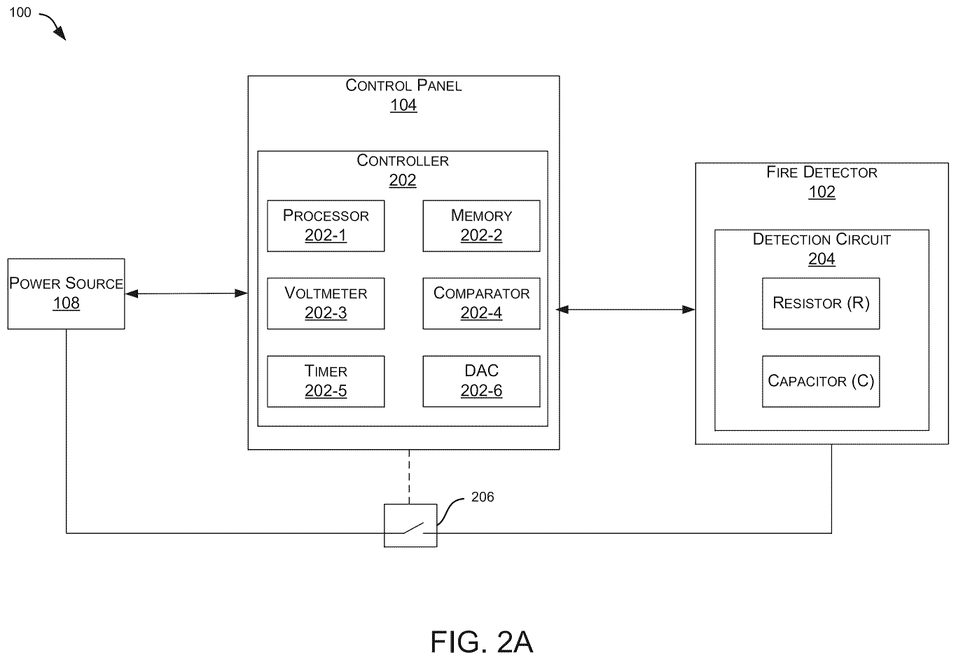

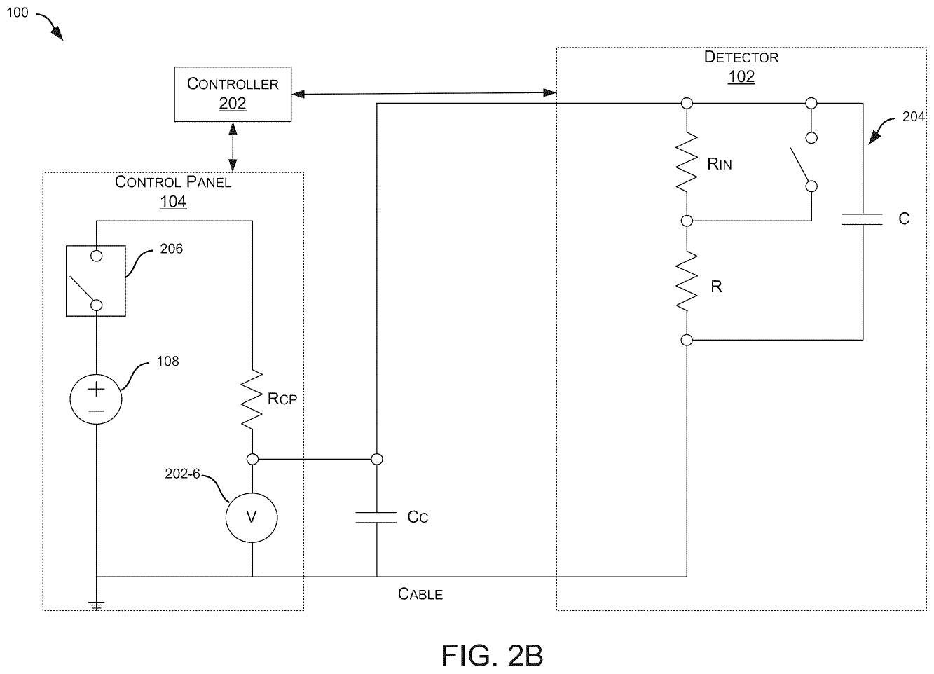

Referring to FIGS. 1 to 2B, a fire detection system having a plurality of fire detectors is disclosed, where the fire detectors are configured with a tampering detection circuit. The fire detection system 100 (also referred to as system 100, hereinafter) may include a plurality of fire detectors 102-1 to 102-N (collectively referred to as fire detectors 102, herein) connected to a control panel 104 via a field equipment cable in a loop. In addition, the system 100 may also include one or more alarm units 106 that may include a speaker, a sounder, lights, and/or indicators, which may also be connected to the control panel 104 via the cable. The control panel 104 may be configured to connect the fire detectors 102 and the alarm units 104 to an electrical power source 108, and further monitor and control the operation of the fire detection system 100. In one or more embodiments, the power source 108 may be associated with an area of interest (AOI) such as but not limited to a building, a vehicle, or a premise where the fire detection system is installed. However, the power source 108 may also be an external power source (electric grid) or a dedicated power source (a battery bank) of the fire detection system 100.

In one or more embodiments, the fire detectors 102 may include but are not limited to smoke detectors, heat or temperature detectors, flame detectors, and one or more gas sensors. The smoke detectors may include but are not limited to ionization detectors and photoelectric detectors. Further, the heat detectors may include but are not limited to fixed temperature detectors that trigger at a set temperature, and rate-of-rise detectors that respond to rapid temperature increases. Furthermore, the flame detector may include but is not limited to infrared and ultraviolet-type flame detectors to sense light emitted by flames. Furthermore, the gas sensors may include but are not limited to carbon monoxide detectors that can identify fire-related CO emissions, carbon dioxide (CO₂) detectors that can identify fire-related CO₂ emissions, and non-volatile emission sensors that may identify fire-related non-volatile particle emissions.

Further, at least one of the fire detectors 102 may include a tamper detection circuit 204 having a reactive impedance. In one or more embodiments, the detection circuit 204 may include a resistor (R) of a predefined resistance, and a capacitor (C) of a predefined capacitance. Further, in some embodiments, the detection circuit 204 may additionally include a predefined inductance (not shown). Thus, the detection circuit 204 may have an effective predefined reactive impedance that may be a function of one or more of the resistance R, the capacitance C, and the inductance associated with the detection circuit 204. In one or more embodiments, the predefined resistance R, the predefined capacitance C, and/or the predefined inductance (not shown) may be additionally configured in the detection circuit 204, in addition to the internal resistance Rin (shown in FIG. 2B), internal capacitance (not shown), and/or internal inductance (not shown) of the detection circuit. However, in other embodiments, the predefined resistance R, the predefined capacitance C, and/or the predefined inductance (not shown) may also be an effective internal resistance, internal capacitance, and internal inductance respectively of the detection circuit. Further, in one or more embodiments, the cable having a capacitance Cc may also be a part of the tampering detection circuit 204, where the effective capacitance of the tampering detection circuit 204 may be a function of the cable capacitance Cc, the predefined resistance R, the predefined capacitance C, and/or the predefined inductance.

It is to be understood that while various embodiments and figures have been described herein for detecting tampering in a fire detector 102 associated with a fire detection system 100, however, the teachings of the subject disclosure may also be implemented for detecting tampering in sensors associated with intrusion detection or monitoring systems that may include motion detectors, occupancy sensors, glass-break detectors, vibrations sensors, video surveillance system, fence and perimeters alarms, seismic detectors, shock detectors, doors and windows opening sensors, and the likes, and all such embodiments are well within the scope of the subject disclosure.

In one or more embodiments, the system 100 may further include a controller 202 connected to the detection circuit 204 and the fire detectors 102. The controller 202 may include a processor 202-1 with access to a memory 202-2 storing instructions executable by the processor 202-1, which may cause the controller 202 to perform one or more designated operations. In one or more embodiments, the controller 202 may be associated with the control panel 104. However, the controller may also be connected to the control panel 104 of the fire detection system 100 to control the operation of the control panel 104.

In one or more embodiments, the controller 202 may be configured to operate the fire detection system 100 in a tampering detection mode at a predetermined interval or in real-time for monitoring tampering in the detection circuit 204 or the fire alarm system 100. During the tampering monitoring mode, the controller 202 may be configured to issue a detection signal to turn ON or turn OFF the supply of electrical power from the power source 108 to the detection circuit 204 of the fire detector 102. Further, the controller 202 may measure the time taken by a voltage applied across or a current flowing through the detection circuit 204 to reach a predefined value upon ON or turning OFF the electrical power supply to the detection circuit 204. Furthermore, the controller 202 may measure a time constant of the detection circuit 204 based on the measured time taken by the applied voltage or the flowing current to reach the predefined value.

Accordingly, the controller 202 may detect tampering in the corresponding fire detector 102 and/or the cable, if the measured time constant exceeds a predefined threshold. In addition, the controller 202 may issue an alert signal to actuate the alarm units 106 upon detecting tampering in the fire detector 102. Further, if the measured time constant is detected to be equal to the predefined threshold, the controller 202 may identify the detection circuit 204 to be untampered and keep monitoring tampering in the detection circuit 204 at the predetermined interval or in real-time. Furthermore, upon a non-detection in case the calculation is pending or an error is detected at the controller 202 end, the controller 202 may be configured to keep monitoring tampering in the detection circuit 204 at the predetermined interval or in real-time.

Thus, when an individual having access to the wiring of the fire detector 102 tries to disable the detector 102 (without triggering the alarm) by attaching a new resistor of appropriate value (same as the resistor of predefined resistance R being provided within the detector 102 circuit) to the cable and then cutting the wires that lead to the fire detector 102, the individual may remain unaware of the capacitor (or reactive impedance) at its capacitance value (C) being added to the detection circuit 204. As a result, the effective time constant of the fire detector 102 upon adding the new resistor (after tampering) by the individual may remain different from the effective time constant of the untampered fire detector 102, thereby enabling the system 100 to detect tampering in the fire detection system 100 and further generate an alert.

In one or more embodiments, the predefined threshold may be a function of the predefined reactive impedance associated with the detection circuit 204, which may be determined and stored in the memory 202-2 of the controller 202 at the time of commissioning or updating the detection circuit 204 by a registered operator or an admin. For instance, in one or more embodiments, the detector 102 circuit may include the resistor R of the predefined resistance, and the capacitor C of a predefined capacitance as shown in FIG. 2A and 2B. In such embodiments, the detection circuit 204 may have a predefined threshold RC constant that may be a function of the predefined resistance R, and the predefined capacitance C (which may be set at the time of commissioning or updating the detection circuit 204 by the registered operator or the admin). Accordingly, during the tampering monitoring mode, the controller 202 may be configured to measure an RC time constant of the detection circuit 204 and compare the measured RC time constant with the predefined threshold RC constant to identify tampering in the corresponding detection circuit 204 or the fire detector 102. In one or more embodiments, if the measured RC time constant exceeds the predefined threshold RC constant, the controller 202 may detect tampering in the corresponding fire detector 102. Further, if the measured time constant is detected to be equal to the predefined threshold RC constant, the controller 202 may identify the detection circuit 204 or the fire detector 102 to be untampered.

In one or more embodiments, during the tampering monitoring mode, the controller 202 may be configured to issue a detection signal to turn ON the supply of electrical power from the power source 108 to the detection circuit 204. Further, the controller 202 may measure a time delay in the supply of voltage or current to the detection circuit 204 upon turning ON the electrical power supply and correspondingly determine a time taken by the capacitor C associated with the detection circuit 204 to be charged to a steady state (63.2% or 100% of the voltage level of the power source 108, but not limited to the like) using the power received from the power source 108. Furthermore, the controller 202 may determine the time constant of the detection circuit 204 based on the measured time taken by the capacitor C to be charged to the steady state.

Further, in one or more embodiments, during the tampering monitoring mode, the controller 202 may be configured to issue a detection signal to turn OFF the supply of electrical power to the detection circuit 204. Further, the controller 202 may measure a time delay in disabling the supply of voltage or current to the detection circuit 204 upon turning OFF the electrical power supply and correspondingly determine a time taken by the capacitor C associated with the detection circuit 204 to be fully discharged or discharged to a steady state (36.8% of the voltage level of the power source 108). Furthermore, the controller 202 may determine the time constant of the detection circuit 204 based on the measured time taken by the capacitor C to be fully discharged or discharged up to the steady state.

In one or more embodiments, during the tampering monitoring mode, the controller 202 may be configured to issue a detection signal to turn ON the supply of electrical power to the detection circuit 204. The controller 202 may further monitor the amplitude of the voltage or current associated with the electrical power being supplied to the detection circuit 204 and a time delay in the supply of the voltage or current to the detection circuit 204 upon turning ON the electrical power supply. Further, the controller 202 may determine and record the time constant of the detection circuit 204 based on the monitored voltage or current and the monitored time delay.

Further, in one or more embodiments, during the tampering monitoring mode, the controller 202 may be configured to issue a detection signal to turn OFF the supply of electrical power to the detection circuit 204. The controller 202 may further monitor the amplitude of the voltage or current associated with the electrical power being supplied to the detection circuit 204 and a time delay in disabling the supply of the voltage or current to the detection circuit 204 upon turning OFF the electrical power supply. Further, the controller 202 may determine and record the time constant of the detection circuit 204 based on the monitored voltage or current and the monitored time delay.

Referring to FIG. 2B, in one or more embodiments, the controller 202 may include a voltmeter or ammeter 202-3 to monitor the voltage across or current flowing through the RC circuit. Further, the controller 202 may include a comparator 202-4 that may be configured to compare the measured time constant with the predefined threshold range. Furthermore, in one or more embodiments, the controller 202 may include a timer 202-5 to measure the time while monitoring the voltage and current. In addition, the controller 202 may include a digital-to-analog convertor (DAC) 202-6 that may be configured to convert a first digital signal associated with the time constant being measured by the controller 202 into a first analog signal for the comparator 202-4. Further, the DAC 202-6 may also convert a second digital signal associated with the measured time taken by the voltage and the measured time delay into an analog signal for the comparator 202-4.

In one or more embodiments, the comparator 202-4, the timer 202-5, and the DAC 202-6 may be integral components of the controller 202 (for instance in the case of microcontroller 202, and the like). However, in other embodiments, the comparator 202-4, the timer 202-5, and the DAC 202-6 may also be additionally configured with the controller 202 (for instance when the control panel 104 is employed as the controller 202).

It is to be understood that the time constant (t) of the RC circuit associated with the detection circuit 204 of the fire detector 102 (or in general) may indicate how quickly the voltage across the capacitor of the detection circuit 204 charges or discharges to its steady state value. The time constant may be defined as the product of the resistance (R) and the capacitance (C) in the detection circuit 204.

In one or more embodiments, while using a charging method, the controller 202 may issue the detection signal to close a switch 206 (connecting the power source 108 to the detection circuit 204) associated with the power source 108 to turn ON the supply of electrical power to the detection circuit 204. This may apply a step voltage from the power source 108 to the detection circuit 204 (RC circuit), thereby initiating the charging process of the capacitor C associated with the detection circuit 204. The controller 202 may then measure the voltage across the detection circuit 204 using the voltmeter 202-3. Further, in one or more embodiments, while using a discharging method, initially the capacitor C of the detection circuit 204 (RC circuit) may be fully charged by connecting it to the power source 108. Further, the controller 202 may issue the detection signal to open the switch 206 to disconnect the power source 108 from the detection circuit 204 and allow the capacitor C of the detection circuit 204 to be discharged through the resistor of the same detection circuit 204 or a resistor associated with the cable or control panel 104 connected to the detection circuit 204. Again, the controller 202 may measure the voltage across the detection circuit 204 at regular intervals using the voltmeter 202-3.

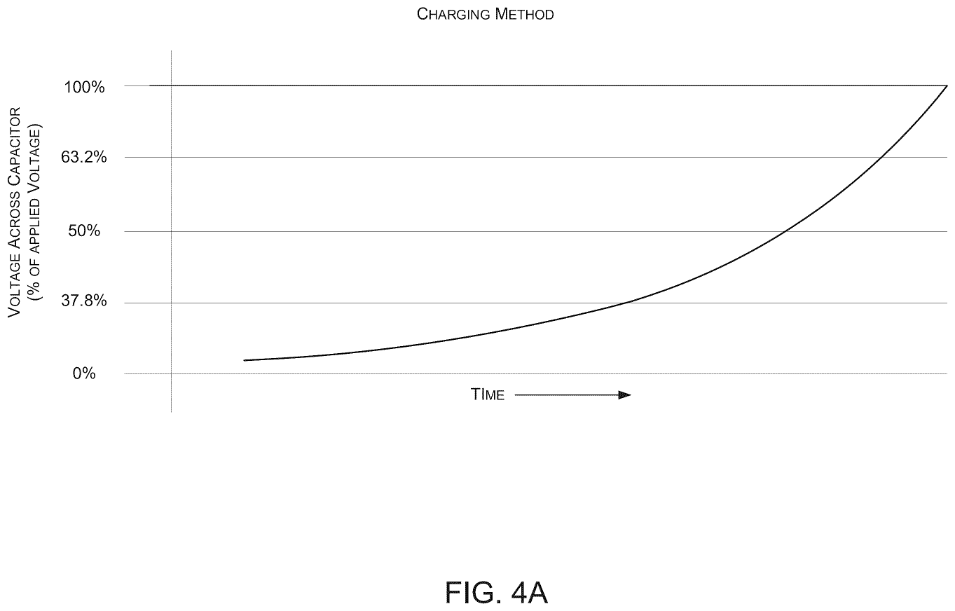

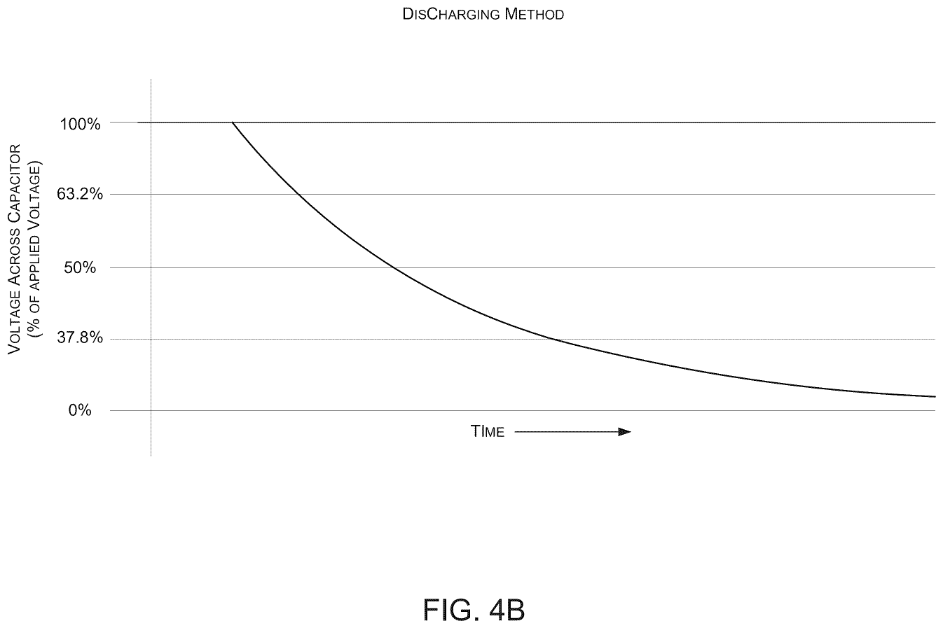

Further, the voltage across the capacitor C or the detection circuit 204 (RC circuit) may be monitored and recorded at different time intervals for both the charging method and the discharging method. The controller 202 may then analyze the voltage data using an exponential charging formula VC(t)=V(1−e−t/t) or an exponential discharging formula VC(t)=Ve−t/t, to generate a voltage plot against time as shown in FIGS. 4A and 4B respectively. As shown in FIG. 4A, while charging the capacitor of the detection circuit 204, the voltage curve may rise exponentially towards a voltage level supplied by the power source 108. Further, as shown in FIG. 4B, while for a discharging capacitor, the voltage curve may fall exponentially towards zero value.

Further, to determine the time constant of the detection circuit 204, the controller 202 may monitor a time (using timer 202-5) when the voltage curve may reach approximately 63.2% of its final value (during charging) or may be decreased to approximately 36.8% of its initial value (during discharging), upon turning ON or turning OFF the electrical power supply to the detection circuit 204. This monitored time may correspond to the time constant (τ) of the detection circuit 204 (RC circuit).

For instance, in a non-limiting example, when the detection circuit 204 is initially untampered at the time of commissioning, if the detection circuit 204 has a resistor of 10 kΩ (predefined resistance) and a capacitor of 100 μF (predefined capacitance), the time constant (predefined threshold value) of the detection circuit 204 is measured to be 1 second (T=RC=1 second). These values of the predefined resistance, the predefined capacitance, and the measured time constant (predefined threshold value) of the detection circuit 204 in the untampered state may be stored in the memory 202-2 of the controller 202 or the control panel 104 at the time of commissioning.

Later, during the tampering detection mode, the amplitude of the voltage across the detection circuit 204 may be monitored upon turning ON or turning OFF the electrical power supply to the detection circuit 204, to detect tampering in the detector 102 circuit or the fire detector 102. For instance, in a non-limiting example, during the charging method, if a 5V supply is applied across the detection circuit 204, and the voltage across the capacitor is measured to approximately reach 3.16 V (63.2% of 5V) after 1 second upon turning ON the electrical power supply to the detection circuit 204, the controller 202 may identify the detection circuit 204 or the fire detector 102 to be untampered. Further, during the discharging method, if the capacitor is initially fully charged to 5V and then the capacitor is allowed to discharge through the resistor, and the voltage across the capacitor is measured to approximately reach 1.84 V (36.8% of 5V) after 1 second upon turning OFF the electrical power supply to the detection circuit 204, the controller 202 may identify the detection circuit 204 or the fire detector 102 to be untampered.

Similarly, in a non-limiting example, during the charging method, if a 5V supply is applied across the detection circuit 204, and the voltage across the capacitor either fails to reach or exceeds 3.16 V (63.2% of 5V) after 1 second upon turning ON the electrical power supply to the detection circuit 204, the controller 202 may identify the detection circuit 204 or the fire detector 102 to be tampered with. Further, during the discharging method, if the capacitor is initially fully charged to 5V and then the capacitor is allowed to discharge through the resistor, and the voltage across the capacitor approximately either fails to reach or exceeds 1.84 V (36.8% of 5V) after 1 second upon turning OFF the electrical power supply to the detection circuit 204, the controller 202 may identify the detection circuit 204 or the fire detector 102 to be in a tampered state.

It should be understood that the above embodiments and examples describe the fire detector circuit 204 as an RC circuit for the sake of brevity, where known values of capacitance C and resistance R are added to or may be a part of the detection circuit 204 for the purpose of detecting tampering in the fire detector 102. Similarly, the detector circuit 204 may also include a reactive impedance to enable the detection of tampering in the fire detector, without any limitations, and all such embodiments are well within the scope of the subject disclosure. Further, while various embodiments and examples have been described herein for detecting tampering in the fire detector, however, the system may also detect tampering in the cable connecting the fire detector to the control panel and all such embodiments are well within the scope of the subject disclosure.

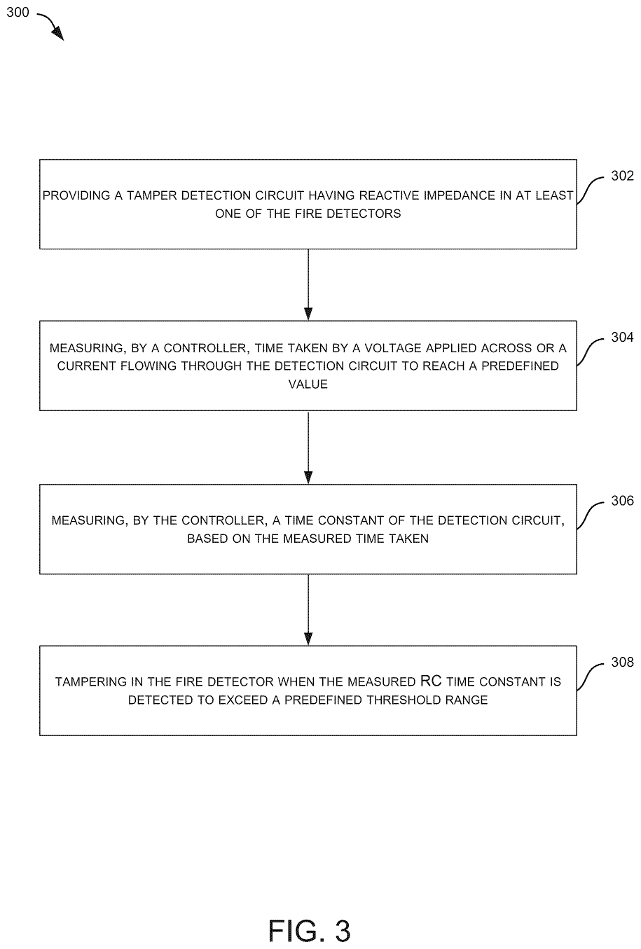

Referring to FIG. 3, method 300 for detecting tampering in a fire detection system having a plurality of fire detectors in a loop is disclosed. Method 300 may involve the tamper detection circuit, the controller, the comparator, the voltmeter, and the DAC associated with the system of FIGS. 1 to 2B.

Method 300 may include step 302 of providing a tamper detection circuit having reactive impedance in at least one of the fire detectors. Method 300 may further include step 304 of measuring, by a controller, time taken by a voltage applied across or a current flowing through the detection circuit to reach a predefined value, followed by another step 306 of measuring, by the controller, a time constant of the detection circuit, based on the measured time taken. Accordingly, method 300 may include step 308 of detecting, by the controller, tampering in the fire detector when the measured RC time constant is detected to exceed a predefined threshold range. Further, when the measured RC time constant is detected to be within the predefined threshold range, the controller may identify and mark the fire detector to be in an untampered state.

In one or more embodiments, at step 304, method 300 may include the steps of issuing, by the controller, a detection signal to turn ON the supply of electrical power to the detector circuit. At step 304, method 300 may further include the steps of measuring, by the controller, a time delay in the supply of voltage or current to the detection circuit upon turning ON the electrical power supply and correspondingly measuring a time taken by a capacitor associated with the detection circuit to be charged to a steady state. Further, at step 306, method 300 may include the steps of determining, by the controller, the time constant of the detection circuit based on the time taken by the capacitor to be charged to the steady state.

In one or more embodiments, at step 304, method 300 may include the steps of issuing, by the controller, a detection signal to turn OFF the supply of electrical power to the detection circuit. At step 304, method 300 may further include the steps of measuring, by the controller, a time delay in disabling the supply of voltage or current to the detection circuit upon turning OFF the electrical power supply and correspondingly measuring a time taken by a capacitor associated with the detection circuit to be fully discharged. Further, at step 306, method 300 may include the steps of determining, by the controller, the time constant of the detection circuit based on the measured time taken by the capacitor to be fully discharged.

In one or more embodiments, at step 304, method 300 may include the steps of issuing, by the controller, a detection signal to turn ON the supply of electrical power to the detection circuit. At step 304, method 300 may further include the steps of monitoring, by the controller, amplitude of voltage or current associated with the electrical power being supplied to the detection circuit, and a time delay in the supply of the voltage or current to the detection circuit upon turning ON the electrical power supply. Further, at step 306, method 300 may include the steps of determining and recording the time constant of the detection circuit based on the monitored voltage or current and the monitored time delay.

In one or more embodiments, at step 304, method 300 may include the steps of issuing, by the controller, a detection signal to turn OFF the supply of electrical power to the detector circuit. At step 304, method 300 may further include the steps of monitoring, by the controller, amplitude of voltage or current associated with the electrical power being supplied to the detection circuit, and a time delay in disabling the supply of voltage or current to the detection circuit upon turning OFF the electrical power supply. Further, at step 306, method 300 may include the steps of determining and recording, by the controller, the RC time constant of the detection circuit based on the monitored voltage or current and the monitored time delay.

Thus, this invention provides a solution to the limitations and shortcomings associated with existing tampering detection systems employed in fire detectors, by providing an improved, secured, and reliable fire detection and alarm system and method by employing an additional capacitor and monitoring the time constant for detecting and preventing unauthorized tampering with the fire detectors.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A fire detection system having a plurality of fire detectors in a loop, wherein at one of the fire detectors comprising:
a tamper detection circuit having reactive impedance; and
a controller connected to the detection circuit, the controller comprises a processor with access to a memory storing instructions executable by the processors, which causes the controller to:
measure time taken by a voltage applied across or a current flowing through the detection circuit to reach a predefined value;
measure a time constant of the detection circuit based on the measured time taken;
detect if the measured time constant exceeds a predefined threshold; and
in response to a positive detection, detect tampering in the fire detector.

2. The system of claim 1, wherein in response to a negative detection and/or upon a non-detection, the controller is configured to monitor the time constant.

3. The system of claim 1, wherein the controller is configured to monitor tampering in the detection circuit at a predetermined interval or in real time.

4. The system of claim 1, wherein the controller is configured to:
issue a detection signal to turn ON or turn OFF supply of electrical power to the detection circuit; and
measure the time constant of the detection circuit upon ON or turning OFF the electrical power supply to the detection circuit.

5. The system of claim 1, wherein the controller is configured to:
issue a detection signal to turn ON supply of electrical power to the detection circuit;
measure a time delay in the supply of voltage or current to the detection circuit upon turning ON the electrical power supply and correspondingly measure a time taken by a capacitor associated with the detection circuit to be charged to a steady state; and
determine the time constant of the detection circuit based on the time taken by the capacitor to be charged to the steady state.

6. The system of claim 1, wherein the controller is configured to:
issue a detection signal to turn OFF supply of electrical power to the detection circuit;
measure a time delay in disabling the supply of voltage or current to the detection circuit upon turning OFF the electrical power supply and correspondingly measure a time taken by a capacitor associated with the detection circuit to be fully discharged; and
determine the time constant of the detection circuit based on the measured time taken by the capacitor to be fully discharged.

7. The system of claim 1, wherein the controller is configured to:
issue a detection signal to turn ON supply of electrical power to the detection circuit;
monitor amplitude of voltage or current associated with the electrical power being supplied to the detection circuit and a time delay in the supply of the voltage or current to the detection circuit upon turning ON the electrical power supply; and
determine and record the time constant of the detection circuit based on the monitored voltage or current and the monitored time delay.

8. The system of claim 1, wherein the controller is configured to:
issue a detection signal to turn OFF supply of electrical power to the detector circuit;
monitor amplitude of voltage or current associated with the electrical power being supplied to the detection circuit and a time delay in disabling the supply of voltage or current to the detection circuit upon turning OFF the electrical power supply; and
determine and record the RC time constant of the detection circuit based on the monitored voltage or current and the monitored time delay.

9. The system of claim 1, wherein the controller comprises a comparator that is configured to compare the measured time constant with the predefined threshold range.

10. The system of claim 9, wherein the controller comprises a digital to analog convertor (DAC) that is configured to:
convert a first digital signal associated with the measured time constant into a first analog signal for the comparator; and/or
convert a second digital signal associated with the measured time taken by the voltage and the measured time delay into an analog signal for the comparator.

11. The system of claim 1, wherein the controller is a control panel associated with the fire detection system.

12. A method for detecting tampering in a fire detection system having a plurality of fire detectors in a loop, the method comprising:
providing a tamper detection circuit having reactive impedance in at least one of the fire detectors;
measuring, by a controller, time taken by a voltage applied across or a current flowing through the detection circuit to reach a predefined value;
measuring, by the controller, a time constant of the detection circuit, based on the measured time taken; and
detecting, by the controller, tampering in the fire detector when the measured RC time constant is detected to exceed a predefined threshold range.

13. The method of claim 12, wherein the method comprises the steps of:
monitoring, by the controller, tampering in the detection circuit at a predetermined interval or in real time.

14. The method of claim 12, wherein the method comprises the steps of:
issuing, by the controller, a detection signal to turn ON supply of electrical power to the detector circuit;
measuring, by the controller, a time delay in the supply of voltage or current to the detection circuit upon turning ON the electrical power supply and correspondingly measuring a time taken by a capacitor associated with the detection circuit to be charged to a steady state; and
determining, by the controller, the time constant of the detection circuit based on the time taken by the capacitor to be charged to the steady state.

15. The method of claim 12, wherein the method comprises the steps of:
issuing, by the controller, a detection signal to turn OFF supply of electrical power to the detection circuit;
measuring, by the controller, a time delay in disabling the supply of voltage or current to the detection circuit upon turning OFF the electrical power supply and correspondingly measuring a time taken by a capacitor associated with the detection circuit to be fully discharged; and
determining, by the controller, the time constant of the detection circuit based on the measured time taken by the capacitor to be fully discharged.

16. The method of claim 12, wherein the method comprises the steps of:
issuing, by the controller, a detection signal to turn ON supply of electrical power to the detection circuit;
monitoring, by the controller, amplitude of voltage or current associated with the electrical power being supplied to the detection circuit and a time delay in the supply of the voltage or current to the detection circuit upon turning ON the electrical power supply; and
determining and recording, by the controller, the time constant of the detection circuit based on the monitored voltage or current and the monitored time delay.

17. The method of claim 12, wherein the method comprises the steps of:
issuing, by the controller, a detection signal to turn OFF supply of electrical power to the detector circuit;
monitoring, by the controller, amplitude of voltage or current associated with the electrical power being supplied to the detection circuit and a time delay in disabling the supply of voltage or current to the detection circuit upon turning OFF the electrical power supply; and
determining and recording, by the controller, the RC time constant of the detection circuit based on the monitored voltage or current and the monitored time delay.

18. The method of claim 12, wherein the method comprises the steps of generating an alert signal upon detecting tampering in the fire detector.

19. The method of claim 12, wherein the controller is a control panel associated with the fire detection circuit.
